(19) United States
(12) Patent Application Publication
(10) Pub. No.: US 2011/0300772 A1
(43) Pub. Date: Dec. 8, 2011

(54) ELECTRICALLY CONDUCTING BUILDING ELEMENT

(75) Inventor: Frank Bo Risvig, Give (DK)

(73) Assignee: LEGO A/S, Billund (DK)

(21) Appl. No.: 13/055,492

(22) PCT Filed: Jul. 3, 2009
(86) PCT No.: PCT/DK2009/050160

§ 371 Date: Apr. 6, 2011

(30) Foreign Application Priority Data
Jul. 25, 2008 (DK) PA 2008 01039

(51) Int. Cl. A63H 33/04; B29C 45/14

(52) U.S. Cl. 446/91; 264/250

(57) ABSTRACT

A building element for a toy building set, comprising a body part 1 with coupling studs 3a, 3b on the top face and complementarily configured coupling means 2a, 2b on the bottom face, and wherein one or more electrical conductors 4a, 4b is/are provided that connect one or more coupling studs with one or more complementarily configured coupling means; and wherein the conductors comprise an electrically insulating and curable material into which a plurality of electrically conductive elements are admixed and distributed, such as fibres or particles, in such a way that the conductor is able to convey he current through the conductor from the coupling stud to an electrical contact face on the complementarily configured coupling means.

The present invention relates to a toy building set in general comprising a number of toy building elements that are, at least on one side, provided with coupling studs or some other kind of protruding coupling elements and, on another side, provided with complementarily configured coupling means that are configured such as to be interconnectable with the protruding coupling elements with a view to interconnection of several ones of that type of toy building elements.

More particularly, the invention concerns a building element and a method of manufacturing such toy building element, and said building element comprising one or more conductors that are built into the building element to the effect that, when joining such elements by building, by interconnection of the protruding coupling elements and the coupling means configured complementarily therewith, it is possible to establish electrical contact between the conductors in two interconnected building elements, which building element has a body part with a top face and a bottom face seen relative to the normal use situation of the building element, and wherein the top face is configured with a number of complementarily configured coupling studs, and wherein the bottom face is configured with complementarily configured coupling means that are configured with a view to interconnection with corresponding coupling studs on another building element; and wherein the body part of the building element is configured from an electrically insulating thermoplastics material, wherein at least one electrically conducting conductor is configured that extends through the body part and connects at least an electrical contact face on at least one coupling stud on the top face of the building element to at least one electrical contact face on one complementarily configured coupling means on the bottom face of the building element.

### STATE OF THE ART

This type of building elements is known in various embodiments as is shown eg in U.S. Pat. No. 6,805,605 and EP patent Nos 191060, 193544, and 259874 that all show known building elements with electrically conductive inserts in the form of electric conductors that electrically connect coupling studs on the top face of the building element to complementarily configured coupling means on the bottom face of the building element.

By use of such type of building elements it can hereby be accomplished that electric functions can be built into a toy building set; and wherein the electric function thus become an integral part of the toy.

### THE OBJECT OF THE INVENTION

Based on this, it is the object of the present invention to provide a building element of the above-mentioned type and a toy building set comprising a building element of the above-mentioned type, by which more options are provided for simple configuration and adaptation of the building elements with a view to establishing electric functions desired to be provided in a given toy building element.

### THE NOVEL TECHNICAL MEANS

It is accomplished in that the conductor in the toy building is completely or partially made up of an electrically insulating and curable, liquid material into which a plurality of electrically conductive elements are admixed and distributed, such as fibres or particles, in such a way that the large number of electrically conducting elements enable the conductor to convey the current through the conductor from the electrical contact face on the coupling stud and to the electrical contact face on the complementarily configured coupling means.

The electrically insulating and curable and liquid material that partially or completely makes up the conductor may be constituted by many different materials, such as materials that cure by chemical setting like two-component materials or materials that cure upon the influence of light or other irradiation. Moreover, materials may be used that cure simply by the liquid material solidifying. According to a preferred embodiment, the electrically conductive material in the body part of the building element as well as in the conductor preferably comprises a thermoplastics material, whereby both parts can easily be manufactured in an injection moulding process.

The electrically conducting material in the conductor may advantageously comprise fibres or particles that consist essentially of carbon.

According to a preferred embodiment the top face of the building element is provided with at least two coupling studs and correspondingly at least two complementarily configured coupling means on its bottom face, and the building element comprises at least two separate conductors that are separated from each other by the electrically insulating material of the body part. Hereby, due to the freedom as to design that is provided by such conductors being formed from a curable, liquid material, a large number of possibilities are provided for configuring the building elements to specific purposes.

Particularly advantageously, the body part of the building element comprises a top plate that has an essentially plane surface forming the top face of the building element, and on which said coupling studs are arranged, and an outer periphery from where on one or more coupling skirts are arranged, and said coupling skirts being made from electrically insulating material and extending from the top plate and downwards on the bottom face of the building element at a given distance; and wherein the complementarily configured coupling means extend from the top plate and downwards on the bottom face of the building element at a distance like the coupling skirts.

In this context, at least one conductor may have at least one connector piece extending between and being electrically connected to the electrical contact faces on two or more separate coupling studs and/or complementarily configured coupling means; and wherein the connector piece of the conductor extends to that side of the top plate that faces away from the surface and between the separate coupling studs and/or the complementarily configured coupling means. Thereby the conductor is protected optimally between the coupling skirts on the building element.

In this context, the height of the coupling studs above the surface of the top plate may be smaller than the distance by which the coupling skirts and the complementarily configured coupling means extend downwards from the top plate to the effect that, when two building elements are interconnected, the coupling studs are unable to touch the connector piece of the conductor.

As mentioned above, the building element is advantageously manufactured by a method that comprises injection moulding in two or more steps and comprising an injection moulding step, wherein the body part of the building element is injection moulded separately; and one or more separate injection moulding steps wherein the conductors of the building element are injection moulded. In this context, the sequence of injection moulding steps may be selected freely in response to purpose and configuration of the element.

Hereby the body part of the building element may first be injection moulded in a mould cavity with an internal mould space that corresponds to the outer shape of the body part without conductors, following which the body part of the building element is arranged in another mould cavity with a mould space corresponding to the final shape of the building element, following which the conductors are made by injection moulding thereof onto the body part of the building element.

To that end, different materials may be used for completely or partially forming the conductors, but an expedient method would be to use thermoplastics for injection moulding of the body part of the building element; and, for injection moulding of the conductors, to use thermoplastics that contain an amount of electrically conducting particles or fibres in a concentration that enables the conductors to conduct current between one or more coupling studs and/or one or more complementarily configured coupling means.

### LIST OF FIGURES

FIG. 1 is a perspective view showing a building element according to the invention, seen in an inclined view from below;

FIG. 2 is a perspective view showing the building element shown in FIG. 1, seen in an inclined view from above;

FIGS. 3 and 4 are perspective views showing an intermediate product of the building element shown in FIGS. 1 and 2, seen in inclined views from above and from below, respectively;

FIGS. 5 and 6 are perspective views showing mould parts for injection moulding the intermediate product shown in FIGS. 3 and 4;

FIGS. 7 and 8 are perspective views showing mould parts for injection moulding the finished building element according to the invention, as shown in FIGS. 1 and 2.

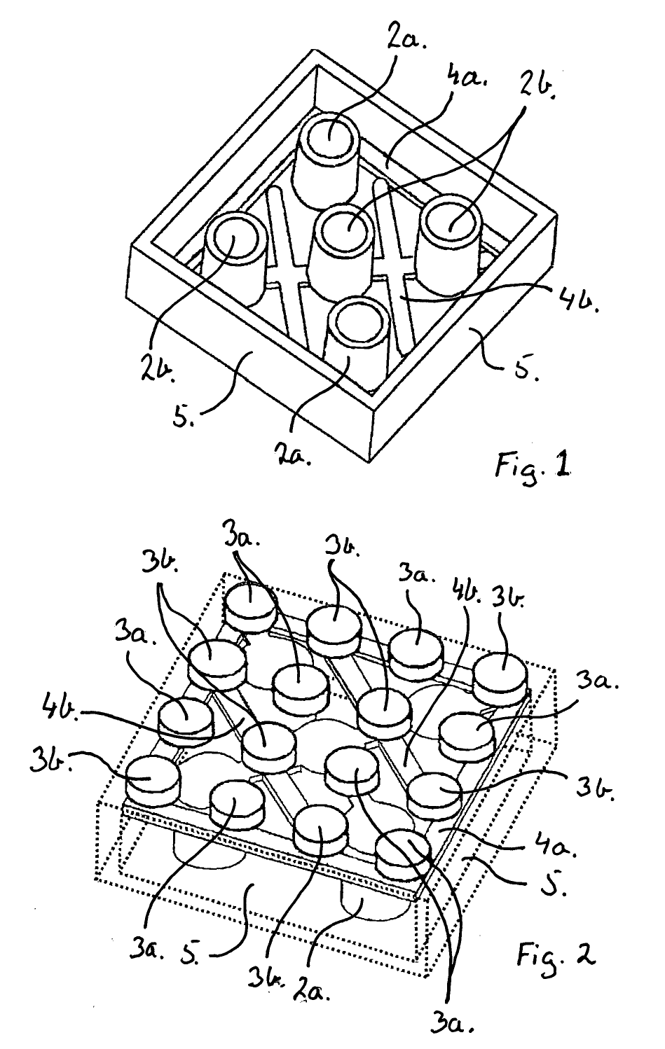

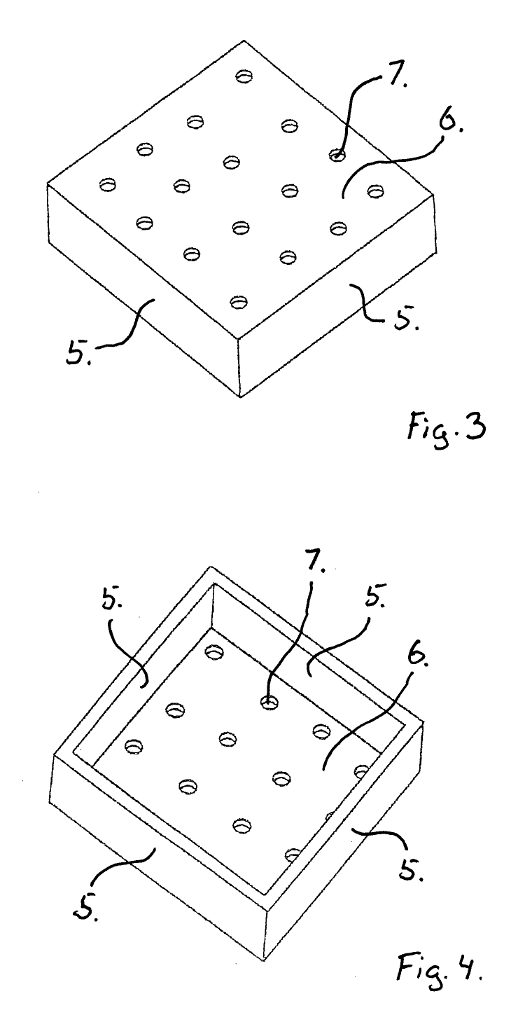

Thus, FIGS. 1 and 2 show an example of a building element according to the present invention, wherein the building element is shown from below in FIG. 2, comprising a substantially square body part 1 with four coupling skirts 5 that are moreover shown as a separate intermediate product in FIGS. 3 and 4. The building element has a plurality of coupling tubulars 2a, 2b that form complementarily configured coupling means relative to the coupling studs 3a, 3b that are shown in FIG. 2. By interconnection of two building elements of this type, the coupling studs 3a, 3b and the complementarily configured coupling means 2a, 2b are configured such that, from a dimension point of view and in a manner known per se, they will press against each other to the effect that friction is established there between when the two building elements are interconnected; and whereby the two building elements are retained relative to each other.

At least in the area where said coupling studs 2a, 2b and coupling tubulars 3a, 3b touch in the event of such interconnection, it will be possible to establish an electrical contact face for transferring electric current in the shape of source current to power an electrical functional element or in the shape of electrical signals for transferring information.

In known toy building sets and to this end, metallic components are built or moulded into the building elements to the effect that these metallic components form conductors that connect those contact faces in the building elements.

According to one embodiment of the present invention, said conductors 4a, 4b are, as shown in FIGS. 1 and 2, established from a moulded, curable material instead, such as thermoplastics containing an amount of fibres or particles of an electrically conductive material, to the effect that the conductors 4a, 4b are able to conduct current between one or more coupling tubulars 2a, 2b and one or more coupling studs 3a, 3b.

Thus, FIGS. 1 and 2 show that the one of the conductors 4a connect the coupling tubulars 2a and the coupling studs 3a electrically to each other.

In the same manner, the other conductor 4b creates electrical connection between the coupling studs 3b and the coupling tubulars 2b.

Thereby a building element has been created that has diagonally extending rows of coupling studs 3a, 3b that are electrically connected to each other, but obviously other configurations of the conductors 4a, 4b may enable establishment of building elements that have other distributions of coupling studs that are electrically connected to each other; and the conductors being configured in a moulding process, there is a high degree of freedom with regard to configuring the conductors with that purpose in mind.

It will be obvious to the person skilled in the art that this design can be configured in other ways, eg by modifying which coupling studs or coupling tubulars connect to each other and optionally allowing one coupling stud and/or one coupling tubular to be in contact with both conductors.

Now, FIG. 3 shows an intermediate product comprising the body part 1 and the coupling skirts 5 on the building element as shown in FIGS. 1 and 2, and from where it will appear that this intermediate product comprises a top plate 6 with apertures 7, wherein said conductors are able to extend through the top plate 6 such that they are thereby able to create an electrical connection between one or more coupling studs 3a, 3b on the top face of the building element and one or more of the coupling tubulars 2a, 2b on the bottom face of the building element.

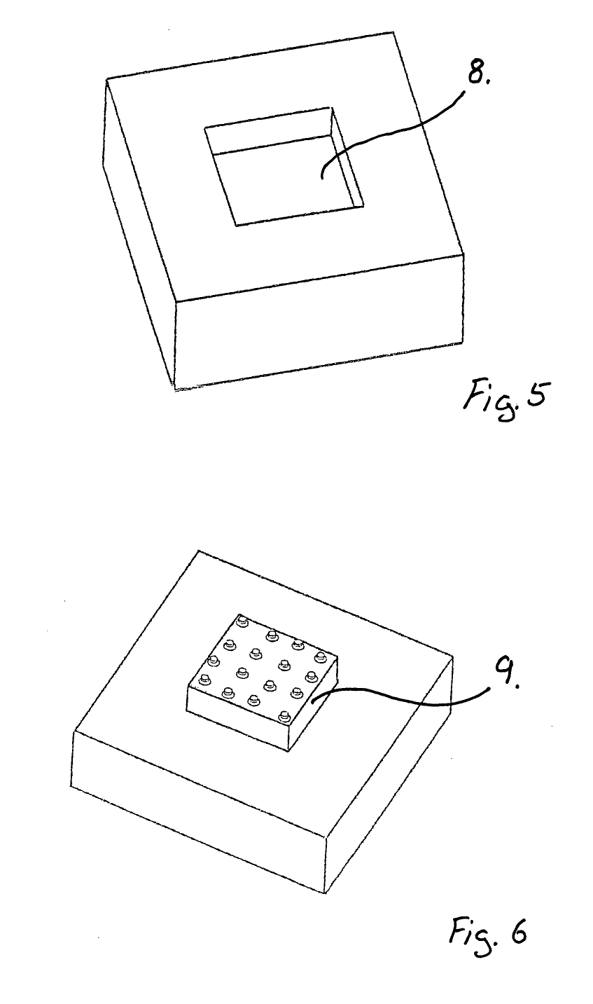

By a preferred manufacturing method according to the present invention, the building element is thus manufactured by initially injection moulding the intermediate product shown in FIGS. 3 and 4 by use of an injection moulding implement comprising the two injection moulding moulds that are shown in FIGS. 5 and 6, wherein FIG. 5 shows a female mould part 8 and FIG. 6 shows the associated male mould part 9. FIGS. 5 and 6 do not show all the constituents of the injection moulding mould parts as it is easy for a person skilled in the art to point to the detailed configuration thereof.

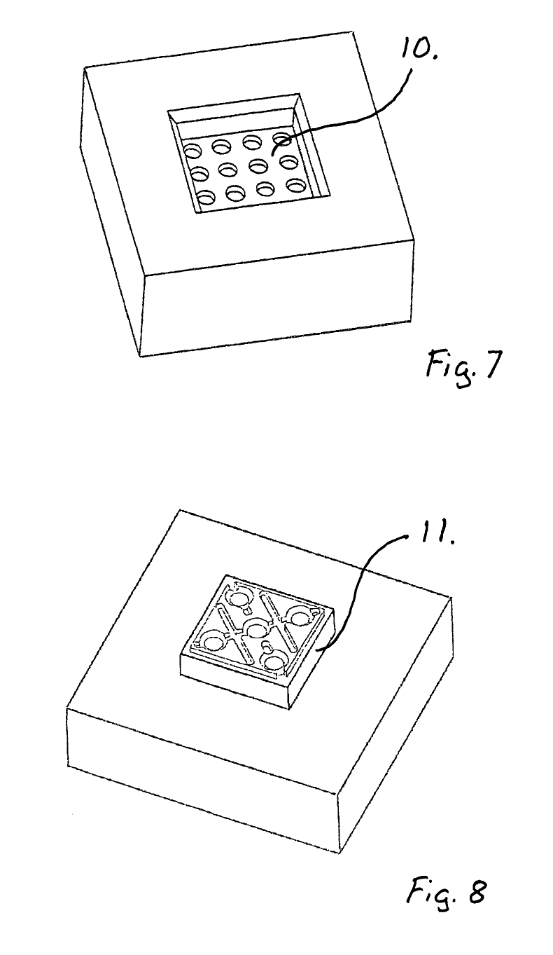

Then the ready moulded intermediate product is arranged in another injection moulding implement as shown in FIGS. 7 and 8, wherein FIG. 7 shows a female mould part 10 and FIG. 8 shows the associated male mould part 11. Hereby it is possible in a known manner to mould the above-mentioned conductors 4a, 4b on the intermediate product along with the electrically conducting coupling tubulars 2a, 2b and the electrically conducting coupling studs 3a, 3b.

Obviously, this manufacturing method and fundamental construction of the building element can be made in other embodiments without thereby departing from the principle of the invention as building elements can be configured with more or fewer coupling studs or coupling tubulars; and it is possible to establish more or fewer separate conductors based on the specific object desired to be accomplished by means of the individual building element. As regards the material for moulding the above-mentioned conductors it may, apart from the use of thermoplastics material with a content of eg metallic or carbon-based fibres or particles, be constituted of materials that cure in other ways than by cooling. Thus, it is possible to use eg materials that solidify or materials that cure chemically, eg in the shape of eg two-component plastics materials or plastics materials that set upon the influence of light or heating or some other influence.

1. A building element for a toy building set, said building element comprising a body part with a top face and a bottom face seen relative to the normal use situation of the building element, and wherein the top surface is configured with a number of coupling studs, and wherein the bottom face is configured with complementarily configured coupling means that are configured with a view to interconnection with corresponding coupling studs on another building element; and wherein the body part of the building element is configured from an electrically insulating thermoplastics material, wherein at least one electrically conducting conductor is configured that extends through the body part and connects at least an electrical contact face on at least one coupling stud on the top face of the building element to at least one electrical contact face on one complementarily configured coupling means on the bottom face of the building element, characterised in that the conductor comprises electrically insulating and curable material into which a plurality of electrically conductive elements are admixed and distributed, such as fibres or particles, in such a way that the large number of electrically conducting elements enables the conductor to convey the current through the conductor from the electrical contact face on the coupling stud and to the electrical contact face on the complementarily configured coupling means.

2. A building element according to claim 1, characterised in that the electrically insulating material in both the body part of the building element and in the conductor comprises thermoplastics.

3. A building element according to claim 1, characterised in that the electrically conducting material in the conductor comprises fibres or particles that are constituted essentially of carbon.

4. A building element according to claim 1, characterised in that, on its top face, the building element has at least two coupling studs and correspondingly at least two complementarily configured coupling means on its bottom side, and wherein the building element comprises at least two separate conductors that are separated from each other by the electrically insulating material of the body part.

5. A building element according to claim 4, characterised in that the body part of the building element comprises a top plate which has an essentially plane surface that forms the top face of the building element; and on which said coupling studs are arranged, and an outer periphery from where one or more coupling skirts are arranged, and said coupling skirts being made from electrically insulating material and extending from the top plate and downwards on the bottom face of the building element at a given distance; and wherein the complementarily configured coupling means extend from the top plate and downwards on the bottom face of the building element at a distance like the coupling skirts.

6. A building element according to claim 5, characterised in that at least one conductor has at least one connector piece extending between and being electrically connected to the electrical contact faces on two or more separate coupling studs and/or complementarily configured coupling means; and wherein the connector piece of the conductor extends to that side of the top plate that faces away from the surface and between the separate coupling studs and/or the complementarily configured coupling means.

7. A building element according to claim 6, characterised in that the height of the coupling studs above the surface of the top plate is smaller than the distance by which the coupling skirts and the complementarily configured coupling means extend downwards from the top plate to the effect that, when two building elements are interconnected, the coupling studs are unable to touch the connector piece of the conductor.

8. A method of manufacturing a building element according to claim 7 characterised in that the building element is made by injection moulding in two or more steps and comprising an injection moulding step, wherein the body part of the building element is injection moulded separately, and one or more separate injection moulding steps wherein the conductors of the building element are injection moulded.

9. A method according to claim 8, characterised in that the body part of the building element is first injection moulded in a mould cavity with an internal mould space that corresponds to the outer shape of the body part without conductors, following which the body part of the building element is arranged in another mould cavity with a mould space corresponding to the final shape of the building element, following which the conductors are made by injection moulding thereof onto the body part of the building element.

10. A method according to claim 9, characterised in that thermoplastics are used for injection moulding of the body part of the building element; and that, for injection moulding of the conductors, thermoplastics are used that contain an amount of electrically conducting particles or fibres in a concentration that enables the conductors to conduct current between one or more coupling studs and/or one or more complementarily configured coupling means.
